(19) United States
(12) Patent Application Publication
(10) Pub. No.: US 2003/0225766 A1
(43) Pub. Date: Dec. 4, 2003

(54) Database access control method, database access control program, and database apparatus

(75) Inventor: Yukihiko Furumoto, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/325,832

(22) Filed: Dec. 23, 2002

(30) Foreign Application Priority Data
May 29, 2002 (JP) 2002-156345

(51) Int. Cl. G06F 17/30

(52) U.S. Cl. 707/9

(57) ABSTRACT

A user authenticating section receives an access request from any one of a plurality of users and authenticates the user. An access controller selects a file format to which an access has been permitted from among a plurality of file formats, based on the access route of the user. An access executing section obtains registration information of a file format that has been selected by the access controller, from a registration information database, and transmits this registration information to the user.

### BACKGROUND OF THE INVENTION

1) Field of the Invention

The present invention relates to a database access control method, a database access control program, and a database apparatus that are suitable for application to an access control of a database. More particularly, the present invention relates to a database access control method, a database access control program, and a database apparatus that can achieve a flexible access control corresponding to an access environment like the access route and that can improve security.

2) Description of the Related Art

FIG. 8 is a block diagram that shows a structure of a conventional database system. The database system shown in FIG. 8 is constructed of user terminals 10₁ to 10ₙ, and a database apparatus 30. The user terminals 10₁ to 10ₙ make an access to the database apparatus 30 via a network 20 and obtain the required information. Each of the user terminals, for example the user terminal 10₁, is a computer (e.g., a desktop computer, a portable computer, etc.). The user terminals make an access to the database apparatus 30 according to a predetermined communication protocol. Further, when each of the user terminals 10₁ to 10ₙ has been authenticated after making access to the database apparatus 30, each of the user terminals 10₁ to 10ₙ obtains desired information stored in the database apparatus 30.

The network 20 is a LAN (local area network), an intranet, the Internet, a dialup network, and the like. The network 20 is provided with a plurality of routers to efficiently select a data transfer route.

The database apparatus 30 is connected to the network 20, and is accessed from the user terminals 10₁ to 10ₙ via the network 20. The database apparatus 30 carries out user authentication when an access has been made from the user, manages information to be transmitted to the user terminal, and transmit information in response to a request made from the user terminal.

In the database apparatus 30, a communication controller 31 is connected to the network 20, and controls communications with the user terminals 10₁ to 10ₙ according to a predetermined communication protocol. When any one of the user terminals 10₁ to 10ₙ has made access from the user terminal, a user authenticating section 32 collates authentication information (a user ID (identifier data) and a password) that has been received from this user terminal with an authentication information database 40, and carries out authentication as to whether the user is an authentic user (regular user).

The authentication information database 40 is a database that stores authentication information (user IDs and passwords) of regular users who have been permitted to make access. Specifically, the authentication information database 40 has fields of the “user ID” and “password”, as shown in FIG. 9.

The “user ID” is an identifier that identifies a regular user. The “password” is prepared using a plurality of digits, and is used together with the “user ID” at the authentication time.

Referring back to FIG. 8, an inquiry processor 33 carries out an inquiry to an access controller 34 regarding an access right level to be described later that is attached to a corresponding user, when a result of the authentication carried out by the user authenticating section 32 indicates that the user is authentic.

The access controller 34 controls an access made to information (a file) that has been requested from the user terminal, by referring to an access control information database 50. The access control information database 50 is a database that stores access control information. Specifically, the access control information database 50 has fields such as the “user ID”, “password”, and “access right level”, as shown in FIG. 10.

The “user ID” and “password” correspond to the “user ID” and “password” in the authentication information database 40 shown in FIG. 9. The “access right level” is a right level of the user terminal (user) that makes access to information (a file) that has been stored in a registration information database 60. In other words, this is a right level of the user that shows to what level of information the user has been permitted to make access.

For example, when the “access right level” is 1, the user can make access to all information (information to which the access right level 1 or 2 has been set). On the other hand, when the “access right level” is 2, the user can make access to only information (a file) to which the access right level 2 has been set, and the user has been prohibited from making access to information (a file) to which the access right level 1 has been set.

Referring back to FIG. 8, an access executing section 35 obtains information (a file) to which the user terminal (user) has been permitted to make access, based on the access control of the access controller 34, and transmits this information (the file) to the user terminal via the network 20 in response to the request.

When information (a file) that has been requested from the user terminal has been the information to which the user terminal has been prohibited from making access, the access executing section 35 notifies an access error to this user terminal.

A registration information database 60 is a database that stores registration information. Specifically, the registration information database 60 has fields of the “file” and “access right level”, as shown in FIG. 11.

The “file” is information to be accessed, and this is described with a file name. For example, 3D-A1 is three-dimensional information (stereographic information that can be turned by 360 degrees) of a product A, and 2D-A1 is two-dimensional information (plane image information) of the product A. The two-dimensional information 2D-A1 is lesser in quantity than the three-dimensional information 3D-A1.

The “access right level” corresponds to the “access right level” in the access control information database 50 shown in FIG. 10. In other words, a user terminal (user) with the “access right level” of 1 (see the access control information database 50 shown in FIG. 10) is permitted to make access to all files (information) with the “access right level” of 1 or 2 (see the registration information database 60 in FIG. 11).

A user terminal (user) with the “access right level” of 2 in the access control information database 50 is permitted to make access only to a file with the “access right level” of 2 in the registration information database 60. In other words, the user terminal with the “access right level” of 2 is not allowed to make access to files with the “access right level” other than 2.

The operation of the above conventional database system will be explained based on the following examples. First, a case when after the portable user terminal 10₁ shown in FIG. 8 has been connected to the network 20 via a company LAN, this user terminal 10₁ makes access to the database apparatus 30 via an access route L₁. Then, a case when the user terminal 10₁ moves to a customer outside the company after disconnection from the company LAN, and the user terminal 10₁ makes access to the database apparatus 30 via an access route L₂.

When the user terminal 10₁ is connected to the company LAN, the user operates to make access to the database apparatus 30, and then inputs a user ID, a password, and a file name following the screen.

After the user terminal 10₁ has made access to the database apparatus 30 via the network 20 (for example, the access route L₁), the user terminal 10₁ transmits information of the user ID, the password, and the filename, to the database apparatus 30. A plurality of routers or a single router exists in the access route L₁.

When there has been an access made from the user terminal 10₁, the communication controller 31 receives the information of the user ID, the password, and the file name, from the user terminal 10₁.

The user authenticating section 32 carries out user authentication by referring to the authentication information database 40 (refer to FIG. 9), using the user ID and the password as keys. When a result of the authentication is NG, the user authenticating section 32 notifies an authentication error to the user terminal 10₁.

When a result of the authentication is OK, the user authenticating section 32 delivers the information of the user ID, the password, and the file name from the user terminal 10₁ to the inquiry processor 33. The inquiry processor 33 delivers the user ID, the password, and the file name to the access controller 34, and makes inquiry about the access right level.

The access controller 34 confirms the access right level (for example, 1) of the user terminal 10₁ (the user) from the access control information database 50 (refer to FIG. 10), using the user ID and the password from the inquiry processor 33 as keys. The access controller 34 delivers the information of the file name and the access right level (=1) to the access executing section 35, to make the access executing section 35 execute access control.

In other words, the access executing section 35 confirms the file (3D-A1) and the access right level (=1) from the registration information database 60 that is shown in FIG. 11, using the file name (for example, 3D-A1) as a key.

The access executing section 35 compares the access right level (=1) from the access controller 34 with the confirmed access right level (=1), and decides whether the user terminal 10₁ has been permitted to make access to the file (3D-A1).

The access executing section 35 decides that the user terminal 10₁ has been permitted to make access, and obtains this file (3D-A1) from the registration information database 60. The access executing section 35 transmits this file to the user terminal 10₁ via the network (the access route L₁). As a result, the user terminal 10₁ receives the desired file (3D-A1).

When the user terminal 10₁ has been prohibited from making access to the file (3D-A1), the access executing section 35 notifies the access error to the user terminal 10₁ via the network 20.

The user disconnects the user terminal 10₁ from the company LAN, and moves to a customer outside the company. Then, the user connects the user terminal 10₁ to the network 20 via the dialup network. After carrying out the operation to make access to the database apparatus 30, the user inputs a user ID, a password, and a file name (for example, 3D-A1) following the screen.

Based on this, the user terminal 10₁ makes access to the database apparatus 30 via the network 20 (for example, the access route L₂), and then transmits information of the user ID, the password, and the file name, to the database apparatus 30. The access route L₂ is a route different from the access route L₁.

When there has been an access made from the user terminal 10₁, the user authenticating section 32 receives the information of the user ID, the password, and the file name from the user terminal 10₁.

Thereafter, through the above operation, the access executing section 35 decides that the user terminal 10₁ has been permitted to make access, and obtains this file (3D-A1) from the registration information database 60. The access executing section 35 transmits this file to the user terminal 10₁ via the network 20 (the access route L₂). As a result, user terminal 10₁ receives the desired file (3D-A1) at the customer.

As explained above, according to the conventional database system, the access control of the registration information (a file) stored in the registration information database 60 has been carried out based on a choice between the two of whether making access has been permitted or prohibited.

Thus, a user terminal can obtain the registration information so long as the user terminal has been permitted to make access, even when the access route has changed (from the access route L₁ to the access route L₂) following the change in the access-making position (the company to a customer etc.).

However, when the access route has low security, there has been a problem that the registration information is stolen while the information is being obtained. For example, when the access route L₂ shown in FIG. 8 has a low security level, there is a possibility that registration information (a file) is stolen while the user terminal 10₁ is obtaining this information from the database apparatus 30.

As the access control has been based on a choice between the two, regardless of the fact that various kinds of files have been utilized as multimedia information, it has not been possible to meet sufficiently the need to carry out a flexible access control according to an access environment (such as an access route, a time, a response speed, etc.).

### SUMMARY OF THE INVENTION

It is an object of the present invention to provide a database access control method, a database access control program, and a database apparatus that can achieve a flexible access control corresponding to an access environment like the access route and that can improve security.

The database access control program according to one aspect of the present invention makes a computer function as follows. That is a receiving unit that receives an access request from a user terminal, selecting unit that selects data to which an access has been permitted from among pieces of data, based on an access route of the user terminal, and a transmitting unit that transmits registration information of the selected data to the user terminal.

The database access control method according to another one aspect of the present invention comprises a receiving step of receiving an access request from a user terminal, a selecting step of selecting data to which an access has been permitted from among pieces of data, based on an access route of the user terminal, and a transmitting step of transmitting registration information of the selected data to the user terminal.

The database apparatus according to still another aspect of the present invention comprises a receiving unit that receives an access request from a user terminal, a selecting unit that selects data to which an access has been permitted from among pieces of data, based on an access route of the user terminal, and a transmitting unit that transmits registration information of the selected data to the user terminal.

These and other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a block diagram that shows a structure of a database system according to one embodiment of the present invention.

FIG. 2 is a diagram that shows the contents of an authentication information database 500 that is shown in FIG. 1.

FIG. 3 is a diagram that shows the contents of an access control information database 600 that is shown in FIG. 1.

FIG. 4 is a diagram that shows the contents of a registration information database 700 that is shown in FIG. 1.

FIG. 5 is a flowchart that explains a registration processing according to the embodiment.

FIG. 6 is a flowchart that explains an access processing according to the embodiment.

FIG. 7 is a block diagram that shows a structure of a modification of the database system according to the embodiment.

FIG. 8 is a block diagram that shows a structure of a conventional database system.

FIG. 9 is a diagram that shows the contents of an authentication information database 40 that is shown in FIG. 8.

FIG. 10 is a diagram that shows the contents of an access control information database 50 that is shown in FIG. 8.

FIG. 11 is a diagram that shows the contents of a registration information database 60 that is shown in FIG. 8.

### DETAILED DESCRIPTIONS

The database access control method, the database access control program, and the database apparatus according to one embodiment of the present invention will be explained in detail below with reference to the attached drawings.

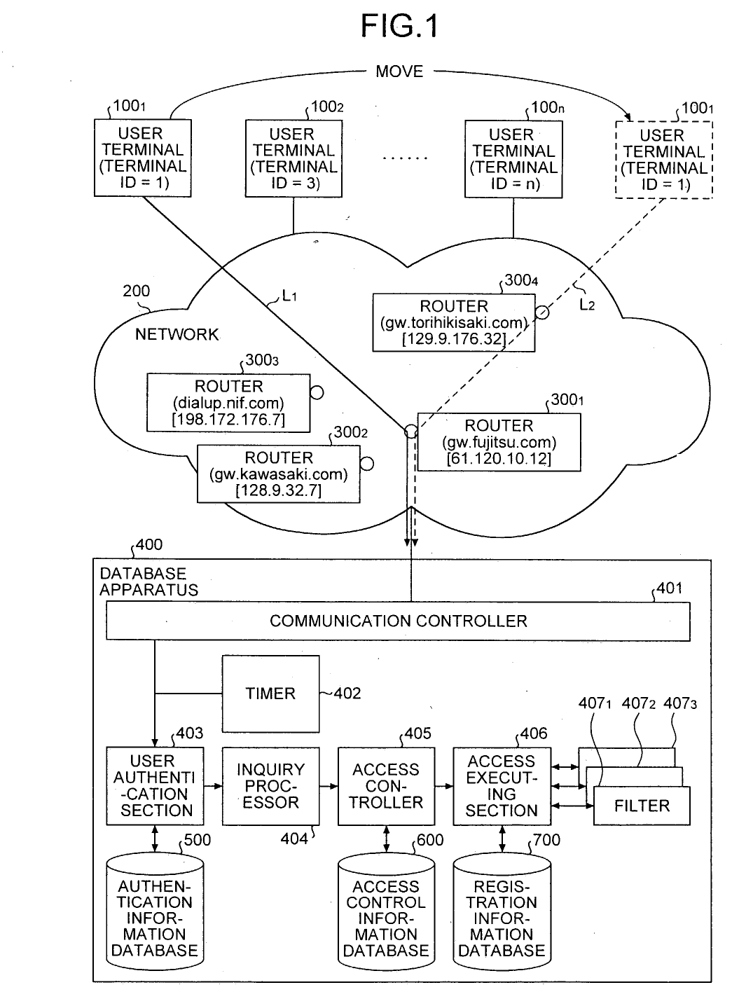

FIG. 1 is a block diagram that shows a structure of a database system according to one embodiment of the present invention. The database system shown in FIG. 1 is constructed of user terminals 100₁ to 100ₙ, and a database apparatus 400 that is accessed from the user terminals 100₁ to 100ₙ via a network 200 and that transmits information to the user terminals corresponding to requests.

Each of the user terminals 100₁ to 100ₙ is a computer terminal (a desktop type, a portable type, etc.) that is connected to the network 200 and makes access to the database apparatus 400 according to a predetermined communication protocol. Further, when each of the user terminals 100₁ to 100ₙ has been authenticated after making access to the database apparatus 400, each obtains desired information that has been stored in the database apparatus 400.

The network 200 is a LAN, an intranet, the Internet, a dialup network, or the like. The network 200 is provided with a plurality of routers including a router 300₁, a router 300₂, a router 300₃, and a router 300₄ to efficiently select a data transfer route.

In the network 200, positions of the routers 300₁ to 300₄ are specified by host names and IP (Internet Protocol) addresses that have been registered in a known DNS (Domain Name System). Host names and IP addresses of the routers 300₁ to 300₄ will be listed in the table below.

| Router | Host name | IP address |
|---|---|---|
| router 300₁ | gw.fujitsu.com | 61.120.10.12 |
| router 300₂ | gw.kawasaki.com | 128.9.32.7 |
| router 300₃ | dialup.nif.com | 198.172.176.7 |
| router 300₄ | gw.torihikisaki.com | 129.9.176.32 |

Each of the user terminals 100₁ to 100ₙ checks an access route (access routes L₁ and L₂ in FIG. 1) to the database apparatus 400 based on a traceroute command at the time of making access to the database apparatus 400, and notifies information of the access route to the database apparatus 400. The information of the access route is expressed using a host name and an IP address that exist on the route from the user terminal to the database apparatus 400.

The traceroute command utilizes a system of TTL (time to live) in order to find each router that exists on the access route. The TTL is a live time that can be assigned to an IP package header. However, in actual practice, the TTL means a number of hops instead of time. In other words, the TTL assigns the number of hops in which the IP packet can exist.

Specifically, according to the traceroute command, a result of an access route is obtained after repeating a trial of sequentially increasing the TTL starting from 1. For example, the user terminal 100₁ transmits the IP package to a host concerned (the database apparatus 400) starting from 1 for the TTL. At a point when the first (first hop) router has received the IP packet, a result of subtracting 1 from the TTL=1 becomes TTL=0. Therefore, the router notifies the information of a host name and an IP address as a first result to the user terminal 100₁, as an error.

The user terminal 100₁ then transmits the IP packet to the host (the database apparatus 400) by setting 2 to the TTL. At a point when the second (second hop) router has received the IP packet, a result of subtracting 1 from the TTL=1 becomes TTL=0. Therefore, the router notifies the information of a host name and an IP address as a second result to the user terminal 100₁, as an error.

Thereafter, the user terminal 100₁ sequentially transmits the IP address by increasing the TTL until when the IP packet reaches the host (the database apparatus 400). After a result (access route information) of the traceroute command has been obtained, the user terminal 100₁ transmits this information to the database apparatus 400.

Each of the user terminals 100₁ to 100ₙ has been provided with a terminal ID to identify the user terminal. For the terminal ID, there are used a serial number of a processor, a MAC (media access control) address, etc. that are own to the terminal.

The database apparatus 400 is connected to the network 200, and is accessed from the user terminals 100₁ to 100ₙ via the network 200. The database apparatus 400 has a function of receiving information of a user ID, a password, a terminal ID, an access route, a file name and the like, when accessed.

The database apparatus 400 has a function of carrying out user authentication when accessed, a function of managing information to be transmitted to the user terminal, and a function of transmitting information to make response to a request made from the user terminal.

In the database apparatus 400, a communication controller 401 is connected to the network 200, and controls communications with the user terminals 100₁ to 100ₙ according to a predetermined communication protocol. A timer 402 functions as a clock unit, and delivers date and time information to a user authenticating section 403.

When there has been an access made from any one of the user terminals 100₁ to 100ₙ, the user authenticating section 403 collates information of a user ID, a password, and an access route that have been received from this user terminal with an authentication information database 500, and carries out authentication as to whether this user is a regular user.

The authentication information database 500 is a database that stores authentication information (user IDs, passwords, terminal IDs, access routes, and periods) of regular users who have been permitted to make access.

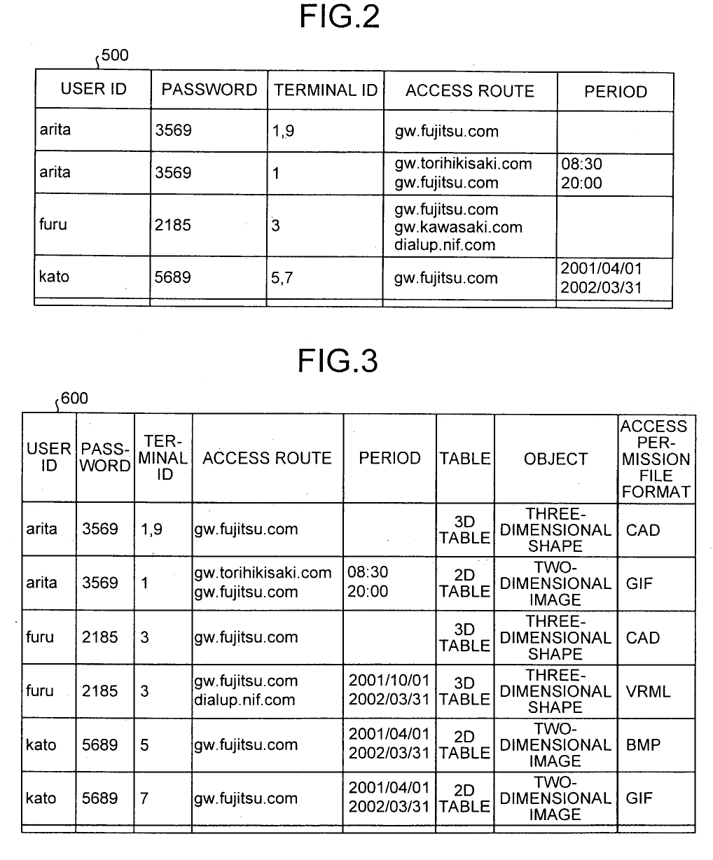

The authentication information database 500 has fields that are called “user ID”, “password”, “terminal ID”, “access route”, and “period”, as shown in FIG. 2.

The “user ID” is an identifier that identifies a regular user. The “password” is prepared using a number of a plurality of digits, and is used together with the “user ID” at the authentication time. The “terminal ID” is an identifier that identifies each of the user terminals 100₁ to 100ₙ.

The “access route” is information of a host name of the router on the network 200, and this access route is collated with the access route that has been notified from a user terminal when the access has been made. The “period” is information relating to a period (a time zone, and year, month, and day) when an access is permitted. When the “period” has not been set, this means that there is no time limit to the access permission.

Referring back to FIG. 1, an inquiry processor 404 carries out an inquiry to an access controller 405 regarding an access permission, when a result of the authentication carried out by the user authenticating section 403 has been OK.

The access controller 405 controls an access made to information (a file) that has been requested from the user terminal, by referring to an access control information database 600. The access control information database 600 is a database that stores access control information.

The access control information database 600 has fields that are called “user ID”, “password”, “terminal ID”, “access route”, “period”, “table”, “object”, and “access permission file format”, as shown in FIG. 3.

The “user ID”, the “password”, the “terminal ID”, the “access route”, and the “period” correspond to the “user ID”, the “password”, the “terminal ID”, the “access route”, and the “period” respectively in the authentication information database 500 shown in FIG. 2.

The “access route” has been set such that a file format of a quantity of information corresponding to security of the access route of a user terminal is selected from among a plurality of file formats, based on a result of checking the security of a plurality of access routes that has been carried out in advance.

The “access route” has been set as follows. When the security level of the access route is at or lower than a threshold value, a file format that has a smallest quantity of information is selected from among a plurality of file formats. On the other hand, when a security level of the access route of a user terminal is higher than the threshold value, a file format that has a largest quantity of information is selected from among the file formats.

The security level corresponds to a number of hops (a number of routers) in the access route. The security level is higher when the number of hops is smaller, and the securing level is lower when the number of hops is larger.

In the present embodiment, the “access route” may be set such that a file format of a quantity of information corresponding to a response speed of the access route of a user terminal is selected from among a plurality of file formats, based on a result of checking the response speed of a plurality of access routes that has been carried out in advance.

The “access route” is set as follows. When the response speed of the access route of a user terminal is at or lower than a threshold value, a file format that has a smallest quantity of information is selected from among a plurality of file formats. On the other hand, when a response speed of the access route of a user terminal is higher than the threshold value, a file format that has a largest quantity of information is selected from among the file formats.

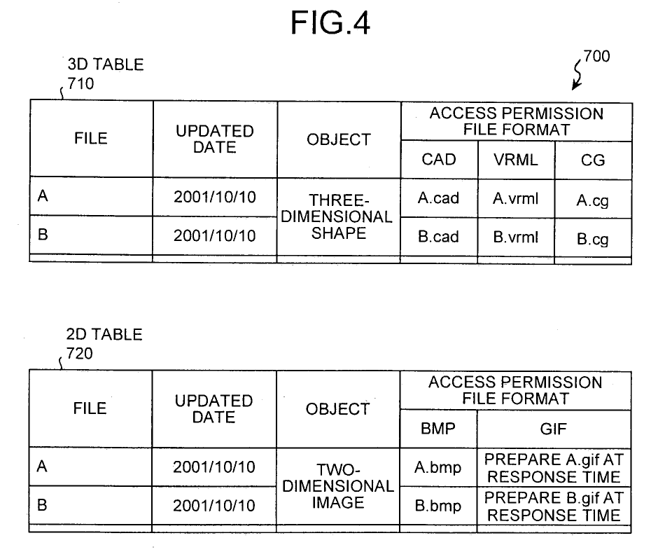

The “table” shows to which one of a 3D (three-dimensional) table 710 and a 2D (two-dimensional) table 720 that are stored in a registration information database 700 (refer to FIG. 4) the user terminal (user) has been permitted to make access. The 3D table corresponds to the 3D table 710 (refer to FIG. 4), and the 2D table corresponds to the 2D table 720 (refer to FIG. 4).

The registration information database 700 shown in FIG. 4 is a database that stores registration information, and is constructed of the 3D table 710 and the 2D table 720.

The 3D table 710 is a table that stores a file (information) of a three-dimensional format (stereographic) that has length, width, and depth. On the other hand, the 2D table 720 is a table that stores a file (information) that shows a two-dimensional image. The three-dimensional shape means a shape that has three dimensions (like a perspective view) of a certain product. On the other hand, the two-dimensional image means an image that has two dimensions (like a plane diagram) of the product.

The 3D table 710 has fields that are called “file”, “updated date”, “object”, and “access permission file format”. The “file” is information to be accessed, and is described in a file name. The “updated date” is a date when the file (information) is updated.

The “object” shows whether the file (information) is in a three-dimensional shape or a two-dimensional image (a three-dimensional shape in the 3D table shown in FIG. 4). The “access permission file format” is a file format to which an access has been permitted among a plurality of file formats for the same file including a CAD (Computer Aided Design) format, a VRML (Virtual Reality Modeling Language) format, and a CG (Computer Graphic) format.

The CAD format is a format that shows a stereographic screen that is used in a design or a design system using a computer. The VRML format is a format that is used to support a three-dimensional graphic on the Internet. The CG format is a format that shows a three-dimensional graphic provided with a rendering.

As explained above, the 3D table 710 stores three kinds of files including the CAD format (A.cad), the VRML format (A.vrml), and the CG format (A.cg), for a certain file (a file A, for example). A file of the CAD format is a general-purpose file that is used to prepare files of the VRML format and the CG format based on a filtering to be described later.

The 2D table 720 has fields that are called “file”, “updated date”, “object”, and “access permission file format”. The “file” is information to be accessed, and is described in a file name. The “updated date” is a date when the file (information) is updated.

The “object” shows whether the file (information) is in a three-dimensional shape or a two-dimensional image (a two-dimensional image in the 2D table shown in FIG. 4). The “access permission file format” is a file format to which an access has been permitted among a plurality of file formats for the same file including a BMP (BitMap) format, and a GIF (Graphic Interchange Format) format.

The BMP format is one of formats to store two-dimensional image information. The GIF format is one of formats to store two-dimensional image information, and can handle up to 256 gradations in monochrome, and 256 colors in color.

As explained above, the 2D table 720 stores two kinds of files including the BMP format (A.bmp) and the GIF format (A.gif), for a certain file (a file A, for example). A file of the BMP format is a general-purpose file that is used to prepare files of the GIF format based on a filtering to be described later.

As a file stored in the 3D table 710 corresponds to three-dimensional information, this file has a larger quantity of information than a file stored in the 2D table 720. For example, a file A (A.cad, for example) that is stored in the 3D table 710 has three-dimensional information of length, width, and depth, as compared with a file A (A.bmp, for example) that is stored in the 2D table 720 that has two-dimensional information of length and width. Therefore, the file A has a larger quantity of information.

Referring back to FIG. 3, the “object” corresponds to the “object” in the 3D table 710 and the 2D table 720 (refer to FIG. 4) respectively. The “access permission file format” shown in FIG. 3 corresponds to the “access permission file format” in the 3D table 710 and the 2D table 720 (refer to FIG. 4) respectively.

Referring back to FIG. 1, an access executing section 406 has functions of obtaining information (a file) to which the user terminal (user) has been permitted to make access from the registration information database 700, based on the access control of the access controller 405, and transmitting this information to the user terminal via the network 200 in response.

When information (a file) that has been requested from the user terminal has been the information to which the user terminal has been prohibited from making access, the access executing section 406 notifies an access error to this user terminal.

Each of filters 407₁ to 407₃ has a function of preparing a file of a separate format from a file of a certain format, by filtering.

The filter 407₁ has a function of preparing a file of the VRML format (A.vrml, for example) from a file of the CAD format (A.cad, for example) shown in the 3D table 710 in FIG. 4. The filter 407₂ has a function of preparing a file of the CG format (A.cg, for example) from a file of the CAD format (A.cad, for example) shown in the 3D table 710.

The filter 407₃ has a function of preparing a file of the GIF format (A.gif, for example) from a file of the BMP format (A.bmp, for example) shown in the 2D table 720.

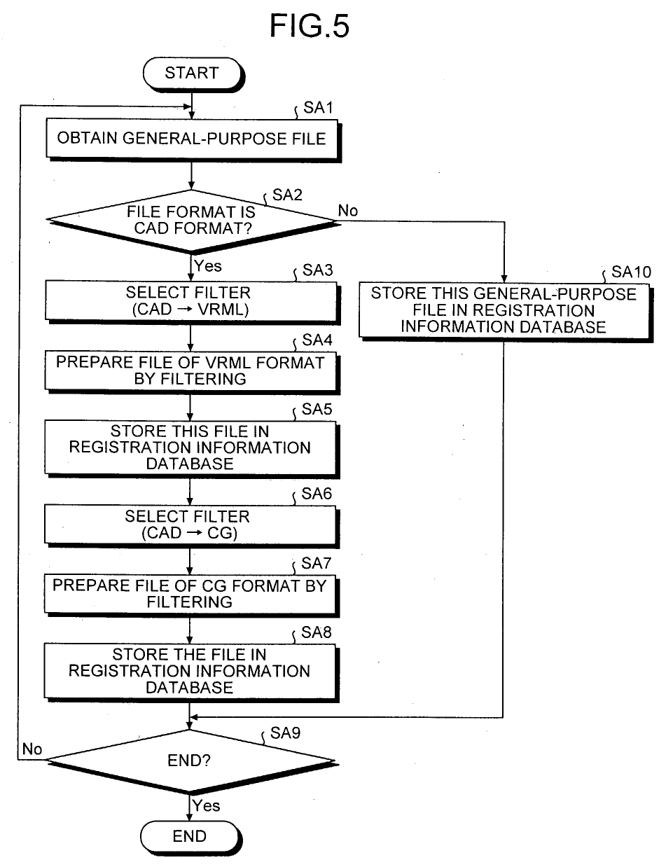

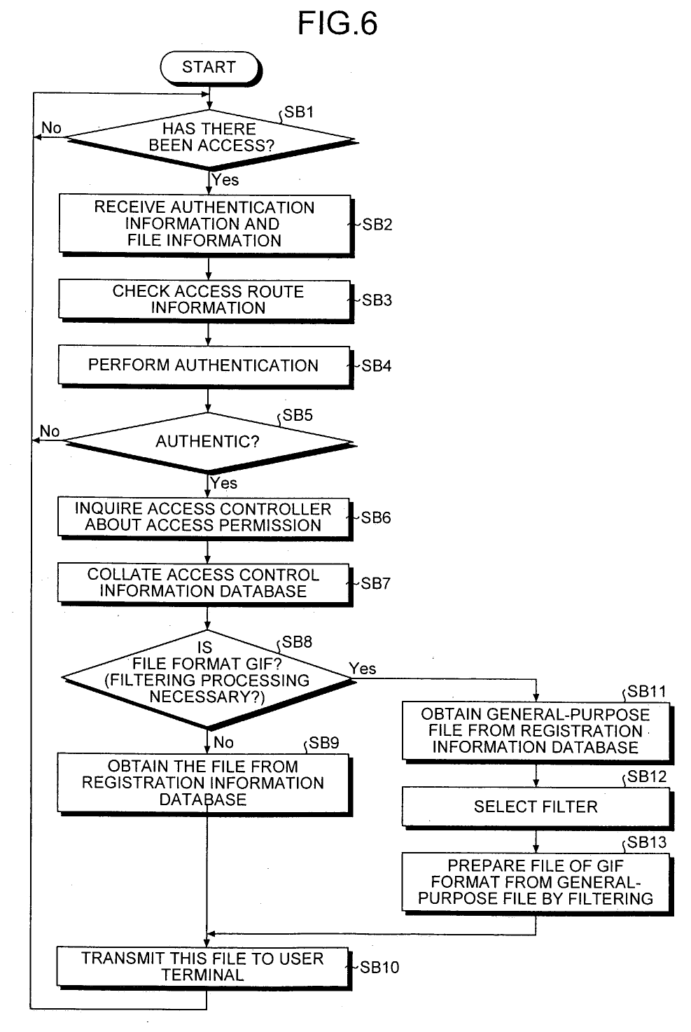

The operation of the embodiment will be explained with reference to flowcharts shown in FIG. 5 and FIG. 6. FIG. 5 is a flowchart that explains a registration processing according to the embodiment. FIG. 6 is a flowchart that explains an access processing according to the embodiment.

A registration of registration information (a file) in the registration information database 700 will be explained with reference to the flowchart shown in FIG. 5. At step SA1 in FIG. 5, the access executing section 406 of the database apparatus 400 obtains a file A.cad of the CAD format (refer to the 3D table 710 in FIG. 4) as a general-purpose file, from an input apparatus not shown.

At step SA2, the access executing section 406 decides whether the format of the general-purpose file obtained at step SA1 is the CAD format. The access executing section 406 decides “Yes” in this example. At step SA3, the access executing section 406 selects the filter 407₁ from among the filters 407₁ to 407₃, in order to prepare a file of the VRML format from the general-purpose file of the CAD format.

At step SA4, the filter 407₁ prepares a file A.vrml of the VRML format from the file A.cad (the general-purpose file) of the CAD format that has been obtained at step SA1. At step SA5, the access executing section 406 stores the file A.vrml of the VRML format that has been prepared at step SA4, as registration information in the 3D table 710 of the registration information database 700, by relating the file A.vrml to the file (A, in this case), the updated date (2001/10/10), and the object (a three-dimensional shape).

At step SA6, the access executing section 406 selects the filter 407₂ from among the filters 407₁ to 407₃, in order to prepare a file of the CG format from a general-purpose file of the CAD format.

At step SA7, the filter 407₂ prepares a file A.cg of the CG format from the file A.cad (the general-purpose file) of the CAD format that has been obtained at step SA1. At step SA8, the access executing section 406 stores the file A.cg of the CG format that has been prepared at step SA7, in the 3D table 710 of the registration information database 700. At step SA9, the access executing section 406 decides whether there has been an instruction to end the registration, and sets “No” as a result of the decision made in this example.

Next, at step SA1, the access executing section 406 of the database apparatus 400 obtains a file B.cad of the CAD format (refer to the 3D table 710 in FIG. 4) as a general-purpose file, from an input apparatus not shown.

At step SA2, the access executing section 406 decides whether the format of the general-purpose file obtained at step SA1 is the CAD format. The access executing section 406 decides “Yes” in this example. At step SA3, the access executing section 406 selects the filter 407₁ from among the filters 407₁ to 407₃, in order to prepare a file of the VRML format from the general-purpose file of the CAD format.

At step SA4, the filter 407₁ prepares a file B.vrml of the VRML format from the file B.cad (the general-purpose file) of the CAD format by filtering that has been obtained at step SA1. At step SA5, the access executing section 406 stores the file B.vrml of the VRML format that has been prepared at step SA4, as registration information in the 3D table 710 of the registration information database 700, by relating the file B.vrml to the file (B, in this case), the updated date (2001/10/10), and the object (a three-dimensional shape).

At step SA6, the access executing section 406 selects the filter 407₂ from among the filters 407₁ to 407₃, in order to prepare a file of the CG format from a general-purpose file of the CAD format.

At step SA7, the filter 407₂ prepares a file B.cg of the CG format from the file B.cad (the general-purpose file) of the CAD format that has been obtained at step SA1. At step SA8, the access executing section 406 stores the file B.cg of the CG format that has been prepared at step SA7, in the 3D table 710 of the registration information database 700. At step SA9, the access executing section 406 decides whether there has been an instruction to end the registration, and sets “No” as a result of the decision made in this example.

Next, at step SA1, the access executing section 406 of the database apparatus 400 obtains a file A.bmp of the BMP format (refer to the 2D table 720 in FIG. 4) as a general-purpose file, from an input apparatus not shown.

At step SA2, the access executing section 406 decides whether the format of the general-purpose file obtained at step SA1 is the CAD format. The access executing section 406 decides “No” in this example.

At step SA10, the access executing section 406 stores the file A.bmp of the BMP format that has been obtained at step SA1, as registration information in the 2D table 720 of the registration information database 700, by relating the file A.bmp to the file (A, in this case), the updated date (2001/10/10), and the object (a two-dimensional image). At step SA9, the access executing section 406 decides whether there has been an instruction to end the registration, and sets “No” as a result of the decision made in this example.

Next, at step SA1, the access executing section 406 of the database apparatus 400 obtains a file B.bmp of the BMP format (refer to the 2D table 720 in FIG. 4) as a general-purpose file, from an input apparatus not shown.

At step SA2, the access executing section 406 decides whether the format of the general-purpose file obtained at step SA1 is the CAD format. The access executing section 406 decides “No” in this example.

At step SA10, the access executing section 406 stores the file B.bmp of the BMP format that has been obtained at step SA1, as registration information in the 2D table 720 of the registration information database 700, by relating the file A.bmp to the file (B, in this case), the updated date (2001/10/10), and the object (a two-dimensional image) At step SA9, the access executing section 406 decides whether there has been an instruction to end the registration. The access executing section 406 sets “Yes” as a result of the decision made in this example, and ends a series of the registration processing.

As explained above, in the registration processing, files of the VRML format and the CG format relating to the three-dimensional information are prepared at the registration time, as it takes time to filter these files because of a large quantity of information. On the other hand, files of the GIF format relating to the two-dimensional information have a relatively smaller quantity of information, and it does not take so much time to filter the files. Therefore, only the general-purpose file of the BMP format is stored in the 2D table 720, and the files of the GIF format are prepared at the time of making response to the user terminal.

The access processing of the embodiment will be explained with reference to the flowchart shown in FIG. 6.

The access processing will be explained based on the following examples. First, a case when after the portable user terminal 100₁ shown in FIG. 1 has been connected to the network 200 via a company LAN, this user terminal 100₁ makes access to the database apparatus 400 via the access route L₁. Then, a case when the user terminal 100₁ moves to a customer outside the company after disconnection from the company LAN, and the user terminal 100₁ makes access to the database apparatus 400 via the access route L₂.

At step SB1 shown in FIG. 6, the user authenticating section 403 of the database apparatus 400 decides whether there has been an access made from any one of the user terminals 100₁ to 100₃. The user authenticating section 403 sets “No” as a result of the decision made in this example, and repeats the same processing.

When the user terminal 100₁ is connected to the company LAN, the user operates to make access to the database apparatus 400, and then inputs a user ID, a password, and a file name following the screen.

After the user terminal 100₁ has made access to the database apparatus 400 via the network 200 (for example, the access route L₁), the user terminal 100₁ transmits information of the user ID (arita, for example), the password (3569, for example), the terminal ID (1, for example), and the file name (A, for example), to the database apparatus 400. The user authenticating section 403 of the database apparatus 400 sets “Yes” as a result of the decision made at step SB1 shown in FIG. 6.

The user terminal 100₁ obtains information of the access route L₁ based on the traceroute command. The access route L₁ passes through only the router 300₁. Therefore, the information of the access route L₁ is the host name (gw.fuitsu.com) of the router 300₁.

At step SB2, the user authenticating section 403 receives the authentication information (the user ID (=arita), the password (=3569), the terminal ID (=1), and the file name (=A)) from the user terminal 100₁. At step SB3, the user terminal 100₁ checks access route information (gw.fujitsu.com) corresponding to the access route L₁. The user authenticating section 403 receives this access route information (gw.fujitsu.com).

At step SB4, the user authenticating section 403 executes the authentication processing by collating the authentication information database 500 (refer to FIG. 2) with the user ID, the password, the terminal ID, the access route, and the date and time information obtained from the timer 402 at the access time, as keys. It is assumed that the authentication information of a first record of the authentication information database 500 coincides with the obtained information.

At step SB5, the user authenticating section 403 decides whether a result of the authentication is OK (coincides). The user authenticating section 403 sets “Yes” as a result of the decision made in this example. When a result of the authentication is NG, the user authenticating section 403 sets “No” as a result of the decision made at step SB5, and notifies an authentication error to the user terminal 100₁.

At step SB6, the user authenticating section 403 delivers the information of the user ID, the password, the terminal ID, the access route, the period, and the file name relating to the user terminal 100₁, to the inquiry processor 404. The inquiry processor 404 delivers the information of the user ID, the password, the terminal ID, the access route, the period, and the filename, to the access controller 405, and inquires about the access permission.

At step SB7, the access controller 405 confirms the “table” (the 3D table, in this case), the “object” (a three-dimensional shape, in this case), and the “access permission file format” (the CAD, in this case) that have been permitted to the user terminal 100₁ (user), at the first record of the access control information database 600 (refer to FIG. 3), using the information of the user ID (=arita) the password (=3569), the terminal ID (=1), the access route (gw.fujitsu.com), the period (no period, in this case), and the file name (=A), that have been received from the inquiry processor 404, as keys.

The access controller 405 delivers the information of the “table” (the 3D table, in this case), the “object” (a three-dimensional shape, in this case), the “access permission file format” (the CAD, in this case), and the file (A, in this case), to the access executing section 406, to make the access executing section 406 execute access control.

At step SB8, the access executing section 406 decides whether the “access permission file format” is the GIF, that is, whether it is necessary to carry out a filtering processing at the response time. As the “access permission file format” is the CAD in this case, the access executing section 406 sets “No” as a result of the decision made at step SB8.

At step SB9, the access executing section 406 obtains a file A.cad of the three-dimensional CAD format from the 3D table 710 of the registration information database 700 shown in FIG. 4, using the “table” (the 3D table, in this case), the“object” (a three-dimensional shape, in this case), the “access permission file format” (the CAD, in this case), and the file (A, in this case), as keys.

At step SB10, the access executing section 406 transmits the obtained file A.cad of the three-dimensional CAD format to the user terminal 100₁. At step SB1, it is decided whether there has been an access made.

The user disconnects the user terminal 100₁ from the company LAN, and moves to a customer outside the company. Then, the user connects the user terminal 100₁ to the network 200. After carrying out the operation to make access to the database apparatus 400, the user inputs the user ID (=arita), the password (=3569), and the file name (=A), following the screen as before.

Based on this, the user terminal 100₁ makes access to the database apparatus 400 via the network 200 (for example, the access route L₂), and then transmits information of the user ID (=arita), the password (=3569), the terminal ID (=1), and the file (=A) to the database apparatus 400. The user authenticating section 403 of the database apparatus 400 sets “Yes” as a result of the decision made at step SB1 shown in FIG. 6.

The user terminal 100₁ obtains information of the access route L₂ based on the trace route command. This access route L₂ is different from the access route L₁. Specifically, the access route L₂ passes through the router 300₄ and the router 300₁. Therefore, the information of the access route L₂ is the host name (gw.torihikisaki.com) of the router 300₄ and the host name (gw.fujitsu.com) of the router 300₁. This access route L₂ has a lower securing level than the access route L₁.

At step SB2, the user authenticating section 403 receives the authentication information (the user ID (=arita), the password (=3569), the terminal ID (=1), and the file name (=A)) from the user terminal 100₁. At step SB3, the user terminal 100₁ checks access route information (gw.torihikisaki.com, gw.fujitsu.com) corresponding to the access route L₂. The user authenticating section 403 receives this access route information (gw.torihikisaki.com, gw.fujitsu.com).

At step SB4, the user authenticating section 403 executes the authentication processing by collating the authentication information database 500 (refer to FIG. 2) with the user ID, the password, the terminal ID, the access route, and the date and time information obtained from the timer 402 at the access time, as keys. It is assumed that the authentication information of a second record of the authentication information database 500 coincides with the obtained information.

At step SB5, the user authenticating section 403 decides that a result of the authentication is OK (the date and time information is within the time zone), and sets “Yes” as a result of the decision made. At step SB6, the user authenticating section 403 delivers the information of the user ID, the password, the terminal ID, the access route, the period, and the file name relating to the user terminal 100₁, to the inquiry processor 404. The inquiry processor 404 delivers the information of the user ID, the password, the terminal ID, the access route, the period, and the file name, to the access controller 405, and inquires about the access permission.

At step SB7, the access controller 405 confirms the “table” (the 2D table, in this case), the “object” (a two-dimensional image, in this case), and the “access permission file format” (the GIF, in this case) that have been permitted to the user terminal 100₁ (user), at the second record of the access control information database 600 (refer to FIG. 3), using the information of the user ID (=arita) the password (=3569), the terminal ID (=1), the access route (gw.torihikisaki.com, gw.fujitsu.com), the period (08:30 to 20:00, in this case), and the file name (=A), that have been received from the inquiry processor 404, as keys.

The access controller 405 delivers the information of the “table” (the 2D table, in this case), the “object” (a two-dimensional image, in this case), the “access permission file format” (the GIF, in this case), and “the file” (A, in this case), to the access executing section 406, to make the access executing section 406 execute access control.

At step SB8, the access executing section 406 decides whether the “access permission file format” is the GIF, that is, whether it is necessary to carry out a filtering processing at the response time. As the “access permission file format” is the GIF in this case, the access executing section 406 sets “Yes” as a result of the decision made at step SB8.

At step SB11, the access executing section 406 obtains a file A.bmp as a general-purpose file from the 2D table 720 of the registration information database 700 shown in FIG. 4, using the “table” (the 2D table, in this case), the “object” (a two-dimensional image, in this case), the “access permission file format” (the GIF, in this case), and “the file” (A, in this case), as keys.

At step SB12, the access executing section 406 selects the filter 407₃ from among the filters 407₁ to 407₃, in order to prepare a file of the GIF format from the general-purpose file of the BMP format.

At step SB13, the filter 407₃ prepares a file A.gif of the GIF format from the file A.bmp (the general-purpose file) of the BMP format that has been obtained at step SB11. At step SB10, the access executing section 406 transmits the prepared file A.gif of the two-dimensional GIF format to the user terminal 100₁.

As explained above, according to the present embodiment, a file format to which an access has been permitted is selected from among a plurality of file formats shown in FIG. 3, based on the access route (the access route L₁ or L₂) of the user terminal 100₁, for example. The access executing section 406 transmits registration information (a file) of this file format to the user terminal 100₁. Therefore, it is possible to carry out a flexible access control corresponding to an access environment like the access route.

According to the present embodiment, access routes to the authentication information database 500 (refer to FIG. 2) and to the access control information database 600 (refer to FIG. 3) are set respectively, based on a result of checking the security of a plurality of access routes that has been carried out in advance. A file format of the quantity of information corresponding to the security of the access route of the user terminal 100₁ is selected from among the file formats shown in FIG. 3, for example. Therefore, it is possible to carry out a flexible access control corresponding to an access environment like the access route, and it is possible to improve security.

According to the present embodiment, the authentication information database 500 (refer to FIG. 2) and the access control information database 600 (refer to FIG. 3) are set respectively so that a file format of a smallest quantity of information (or a largest quantity of information) is selected from among a plurality of file formats, when the security level of the access route is at or lower than a threshold value (or when the security level of the access route is higher than a threshold value). Therefore, it is possible to carry out a flexible access control corresponding to an access environment like the access route, and it is possible to improve security.

According to the present embodiment, a file (registration information) of a selected file format is prepared from a general-purpose file (general-purpose registration information), using the filter 407₃. The prepared registration information is transmitted to the user terminal 100₁, for example. Therefore, it is not necessary to store the registration information of a plurality of file formats in the registration information database 700.

While one embodiment of the present invention has been explained in detail above with reference to the drawings, detailed structure examples are not limited to this one embodiment, and any design alteration within a range not deviating from the gist of the present invention is included in the present invention.

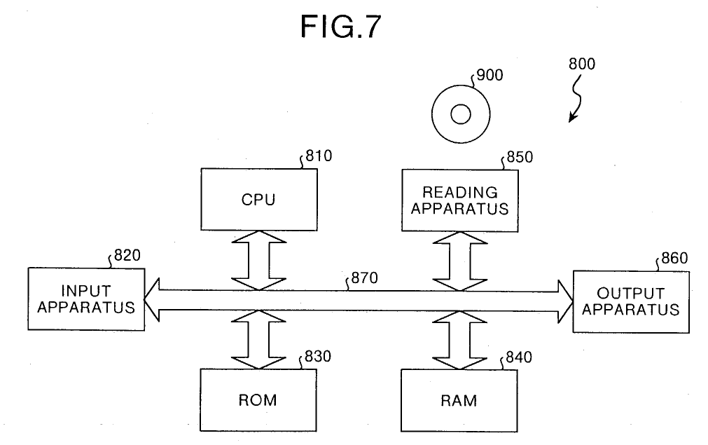

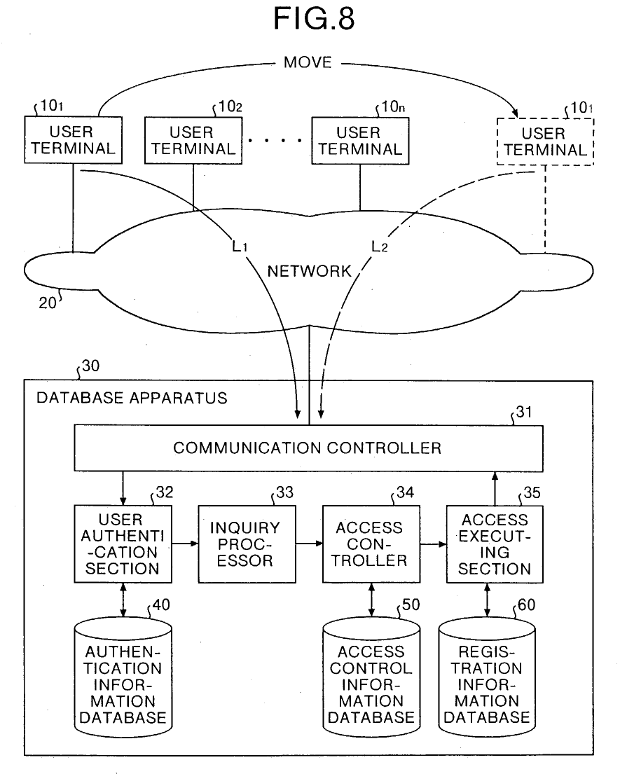

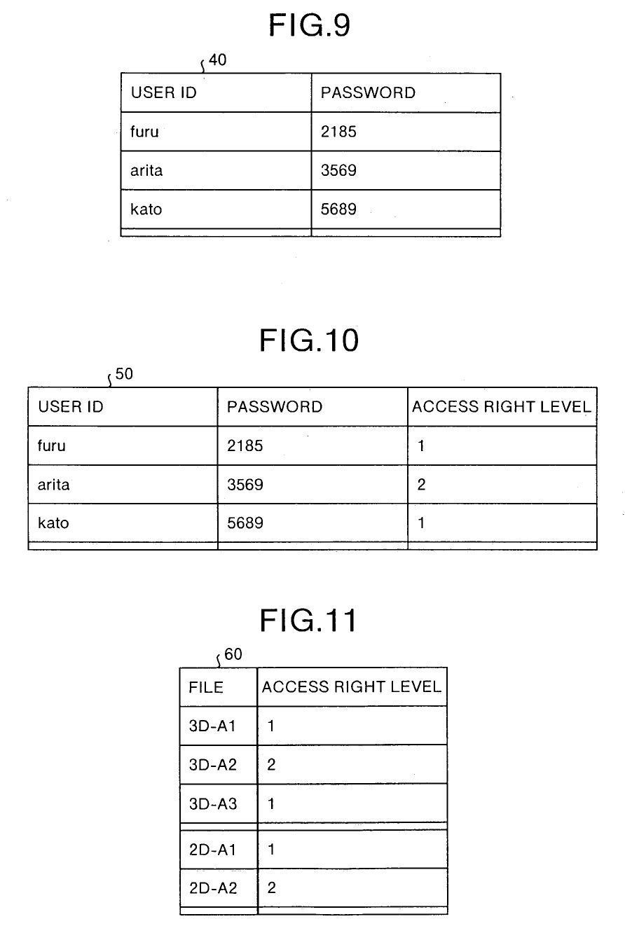

For example, in the above embodiment, a program that realizes the functions of the database apparatus 400 may be recorded on a computer-readable recording medium 900 shown in FIG. 7. Then, a computer 800 shown in FIG. 7 reads and executes the program recorded on this recording medium 900 to realize each function.

In FIG. 7, the computer 800 is constructed of a CPU (Central Processing Unit) 810 that executes the program, an input unit 820 like a keyboard and a mouse, a ROM (Read Only Memory) 830 that stores various kinds of data, a RAM (Random Access Memory) 840 that stores operation parameters, a reading apparatus 850 that reads the program from the recording medium 900, an output apparatus 860 like a display and a printer, and a bus 870 that connects between the apparatuses.

The CPU 810 reads the program that is stored on the recording medium 900 via the reading apparatus 850, and executes the program, thereby to realize the functions. For the recording medium 900, there may be used an optical disk, a flexible disk, a hard disk, etc.

As explained above, according to one aspect of the present invention, data to which an access has been permitted is selected from among pieces of data, based on an access route of a user terminal. Registration information of the data is transmitted to the user terminal. Therefore, there is an effect that it is possible to carry out a flexible access control corresponding to an access environment like the access route.

According to another aspect of the invention, data of a quantity of information corresponding to the security of the access route of the user terminal is selected from among pieces of data, based on a result of checking the security of a plurality of access routes that has been carried out in advance. Therefore, there is an effect that it is possible to carry out a flexible access control corresponding to an access environment like the access route and also to improve the security.

According to still another aspect of the invention, when a security level of an access route of a user terminal is at or lower than a threshold value, data of a smallest quantity of information is selected from among pieces of data. Therefore, there is an effect that it is possible to carry out a flexible access control corresponding to an access environment like the access route and also to improve the security.

According to still another aspect of the invention, when a security level of an access route of a user terminal is higher than a threshold value, data of a largest quantity of information is selected from among pieces of data. Therefore, there is an effect that it is possible to carry out a flexible access control corresponding to an access environment like the access route and also to improve the security.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A database access control program that makes a computer function as:
a receiving unit that receives an access request from a user terminal;
a selecting unit that selects data to which an access has been permitted from among pieces of data, based on an access route of the user terminal; and
a transmitting unit that transmits registration information of the selected data to the user terminal.

2. The database access control program according to claim 1, wherein
the selecting unit selects data of a quantity of information corresponding to the security of the access route of the user terminal from among pieces of data, based on a result of checking the security of a plurality of access routes that has been carried out in advance.

3. The database access control program according to claim 2, wherein
the selecting unit selects data of the smallest quantity of information from among pieces of data, when the security level of the access route of the user terminal is at or lower than a threshold value.

4. The database access control program according to claim 2, wherein
the selecting unit selects data of the largest quantity of information from among pieces of data, when the security level of the access route of the user terminal is higher than a threshold value.

5. The database access control program according to claim 3, wherein
the security level corresponds to a number of hops in the access route, and the security level is higher when the number of hops is smaller, and the security level is lower when the number of hops is larger.

6. The database access control program according to claim 1, wherein
the selecting unit selects data of a quantity of information corresponding to a response speed of the access route of the user terminal from among pieces of data, based on a result of checking the response speed of a plurality of access routes that has been carried out in advance.

7. The database access control program according to claim 6, wherein
the selecting unit selects data of a smallest quantity of information from among pieces of data, when the response speed of the access route of the user terminal is at or lower than a threshold value.

8. The database access control program according to claim 6, wherein
the selecting unit selects data of a largest quantity of information from among pieces of data, when the response speed of the access route of the user terminal is higher than a threshold value.

9. The database access control program according to claim 1, wherein
the selecting unit selects data to which an access has been permitted from among pieces of data, based on also an access time of the user terminal.

10. The database access control program according to claim 1, wherein
the selecting unit selects data to which an access has been permitted from among pieces of data, based on also a terminal identifier of the user terminal.

11. The database access control program according to claim 1, wherein the computer is further made to function as a preparing unit that prepares registration information of data that has been selected by the selecting unit, from general-purpose registration information, and the transmitting unit transmits registration information that has been prepared by the preparing unit, to the user terminal.

12. A database access control method comprising:
a receiving step of receiving an access request from a user terminal;
a selecting step of selecting data to which an access has been permitted from among pieces of data, based on an access route of the user terminal; and
a transmitting step of transmitting registration information of the selected data to the user terminal.

13. The database access control method according to claim 12, wherein
the selecting step selects data of a quantity of information corresponding to the security of the access route of the user terminal from among pieces of data, based on a result of checking the security of a plurality of access routes that has been carried out in advance.

14. The database access control method according to claim 13, wherein
the selecting step selects data of a smallest quantity of information from among pieces of data, when the security level of the access route of the user terminal is at or lower than a threshold value.

15. The database access control method according to claim 13, wherein
the selecting step selects data of a largest quantity of information from among pieces of data, when the security level of the access route of the user terminal is higher than a threshold value.

16. The database access control method according to claim 14, wherein
the security level corresponds to a number of hops in the access route, and the security level is higher when the number of hops is smaller, and the security level is lower when the number of hops is larger.

17. The database access control method according to claim 12, wherein
the selecting step selects data of a quantity of information corresponding to a response speed of the access route of the user terminal from among pieces of data, based on a result of checking the response speed of a plurality of access routes that has been carried out in advance.

18. The database access control method according to claim 17, wherein
the selecting step selects data of a smallest quantity of information from among pieces of data, when the response speed of the access route of the user terminal is at or lower than a threshold value.

19. The database access control method according to claim 17, wherein
the selecting step selects data of a largest quantity of information from among pieces of data, when the response speed of the access route of the user terminal is higher than a threshold value.

20. The database access control method according to claim 12, wherein
the selecting step selects data to which an access has been permitted from among pieces of data, based on also an access time of the user terminal.

21. The database access control method according to claim 12, wherein
the selecting step is for selecting data to which an access has been permitted from among pieces of data, based on also a terminal identifier of the user terminal.

22. The database access control method according to claim 12, further comprising:
a preparing step of preparing registration information of data that has been selected at the selecting step, from general-purpose registration information, wherein
the transmitting step is for transmitting registration information that has been prepared at the preparing step, to the user terminal.

23. A database apparatus comprising:
a receiving unit that receives an access request from a user terminal;
a selecting unit that selects data to which an access has been permitted from among pieces of data, based on an access route of the user terminal; and
a transmitting unit that transmits registration information of the selected data to the user terminal.

24. The database apparatus according to claim 23, wherein
the selecting unit selects data of a quantity of information corresponding to the security of the access route of the user terminal from among pieces of data, based on a result of checking the security of a plurality of access routes that has been carried out in advance.

25. The database apparatus according to claim 24, wherein
the selecting unit selects data of a smallest quantity of information from among pieces of data, when the security level of the access route of the user terminal is at or lower than a threshold value.

26. The database apparatus according to claim 24, wherein
the selecting unit selects data of a largest quantity of information from among pieces of data, when the security level of the access route of the user terminal is higher than a threshold value.

27. The database apparatus according to claim 25, wherein
the security level corresponds to a number of hops in the access route, and the security level is higher when the number of hops is smaller, and the security level is lower when the number of hops is larger.

28. The database apparatus according to claim 23, wherein
the selecting unit selects data of a quantity of information corresponding to a response speed of the access route of the user terminal from among pieces of data, based on a result of checking the response speed of a plurality of access routes that has been carried out in advance.

29. The database apparatus according to claim 28, wherein
the selecting unit selects data of a smallest quantity of information from among pieces of data, when the response speed of the access route of the user terminal is at or lower than a threshold value.

30. The database apparatus according to claim 28, wherein
the selecting unit selects data of a largest quantity of information from among pieces of data, when the response speed of the access route of the user terminal is higher than a threshold value.

31. The database apparatus according to claim 23, wherein
the selecting unit selects data to which an access has been permitted from among pieces of data, based on also an access time of the user terminal.

32. The database apparatus according to claim 23, wherein
the selecting unit selects data to which an access has been permitted from among pieces of data, based on also a terminal identifier of the user terminal.

33. The database apparatus according to claim 23, further comprising:
a preparing unit that prepares registration information of data that has been selected by the selecting unit, from general-purpose registration information, wherein
the transmitting unit transmits registration information that has been prepared by the preparing unit, to the user terminal.
